(19) United States
(12) Patent Application Publication
(10) Pub. No.: US 2025/0093578 A1
(43) Pub. Date: Mar. 20, 2025

(54) Quantum Well In-Line Power Montior

(71) Applicant: Infinera Corporation, San Jose, CA (US)

(72) Inventors: Peter W. EVANS, Terrell, TX (US); Mingzhi LU, Fremont, CA (US)

(73) Assignee: Infinera Corporation, San Jose, CA (US)

(21) Appl. No.: 18/587,931

(22) Filed: Feb. 26, 2024

Related U.S. Application Data
(60) Provisional application No. 63/448,106, filed on Feb. 24, 2023.

(51) Int. Cl. G02B 6/12

(52) U.S. Cl. CPC G02B 6/12004; G02B 6/12002; G02B 2006/12078; G02B 2006/12121; G02B 2006/12128; G02B 2006/12142; G02B 2006/1215

(57) ABSTRACT

Consistent with an aspect of the present disclosure, an apparatus is provided that includes a waveguide included in a photonic integrated circuit that is formed on a substrate. The waveguide includes a core layer that supports propagation of an optical mode having an evanescent tail. An absorbing layer is provided over a portion of the core, such that the evanescent tail of the optical mode extends into the absorbing layer to thereby generate electron-hole pairs in the absorbing layer and provide a photocurrent. The photocurrent can be monitored to indicate performance of devices on the PIC.

### BACKGROUND

The present patent application hereby claims priority to the provisional patent application identified by U.S. Ser. No. 63/448,106 filed on Feb. 24, 2023, the entire content of which is hereby incorporated by reference.

Photonic integrated circuits (PICs) are known which may include multiple optical device providing on a common substrate. These devices may include waveguides that direct light from laser provided on the substrate, as well as light received from a source located remote from the PIC. Light propagating in such waveguides, including a core and a cladding, is often monitored to ensure proper operation of devices integrated on the PIC. For example, a laser fault may be detected by sending a drop in optical power output from the laser.

Conventionally, optical taps may be provided on the PIC to monitor optical power levels by providing a portion of the optical signal propagating in a waveguide to a photodiode, which, in turns, converts the received optical signal portion to an electrical signal indicative of the optical power. Such taps, however, are typically integrated into the core of the waveguide, for example, a core butt joint, or are resonantly coupled to the core. In either case, the tap can cause the optical signal to incur excess loss. Moreover, taps can occupy space on the PIC, thereby increasing the size of the PIC and reducing device density.

### SUMMARY

Consistent with an aspect of the present disclosure, an apparatus is provided that includes a waveguide included in a photonic integrated circuit that is formed on a substrate. The waveguide includes a core layer that supports propagation of an optical mode having an evanescent tail. An absorbing layer is provided over a portion of the core, such that the evanescent tail of the optical mode extends into the absorbing layer to thereby generate electron-hole pairs in the absorbing layer and provide a photocurrent. The photocurrent can be monitored to indicate performance of devices on the PIC.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) and together with the description, serve to explain the principles of the invention.

### BRIEF DESCRIPTION OF THE DRAWINGS

FIG. 1a shows a cross-sectional view of a waveguide and power monitor consistent with an aspect of the present disclosure;

FIG. 1b shows a cross-sectional view of a waveguide and power monitor consistent with another aspect of the present disclosure;

FIG. 1c shows an example of a multiple quantum well structure consistent with an aspect of the present disclosure;

FIG. 2 illustrates an example of a circuit that constitutes part of a PIC consistent with an aspect of the present disclosure;

FIG. 3 illustrates an additional example of a circuit that constitutes part of a PIC consistent with an aspect of the present disclosure;

FIG. 4 illustrates a further example of a circuit that constitutes part of a PIC consistent with an aspect of the present disclosure;

FIG. 5 illustrates another example of a circuit that constitutes part of a PIC consistent with an aspect of the present disclosure;

FIG. 6 illustrates a further example of a circuit that constitutes part of a PIC consistent with an aspect of the present disclosure;

FIG. 7 illustrates an example of a receiver consistent with an aspect of the present disclosure; and

FIG. 8 illustrates an example of an optical transmitter consistent with an aspect of the present disclosure.

### DESCRIPTION OF THE EMBODIMENTS

Consistent with an aspect of the present disclosure, an apparatus is provided that includes a waveguide included in a photonic integrated circuit that is formed on a substrate. The waveguide includes a core layer that supports propagation of an optical mode having an evanescent tail. An absorbing layer is provided over a portion of the core, such that the evanescent tail of the optical mode extends into the absorbing layer to thereby generate electron-hole pairs in the absorbing layer and provide a photocurrent. The photocurrent can be monitored to indicate an optical signal power level, which is indicative of performance of devices on the PIC. In one example, the absorbing layer includes multiple quantum wells.

In a further example, the quantum well is biased to provide a controlled amount of absorption, whereby a relatively large bias across the quantum well results in high absorption and a lower bias results in less absorption. Accordingly, consistent with a further aspect of the present disclosure, the above-described structure may operate as a variable optical attenuator.

Reference will now be made in detail to the present exemplary embodiments of the present disclosure, which are illustrated in the accompanying drawings. Wherever possible, the same reference numbers will be used throughout the drawings to refer to the same or like parts.

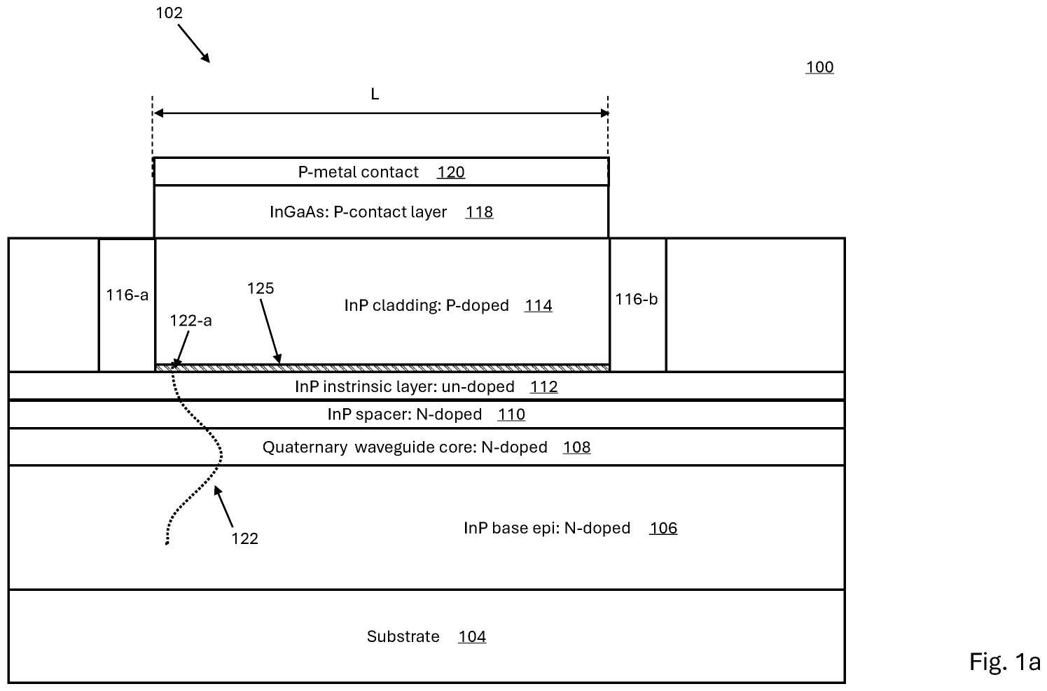

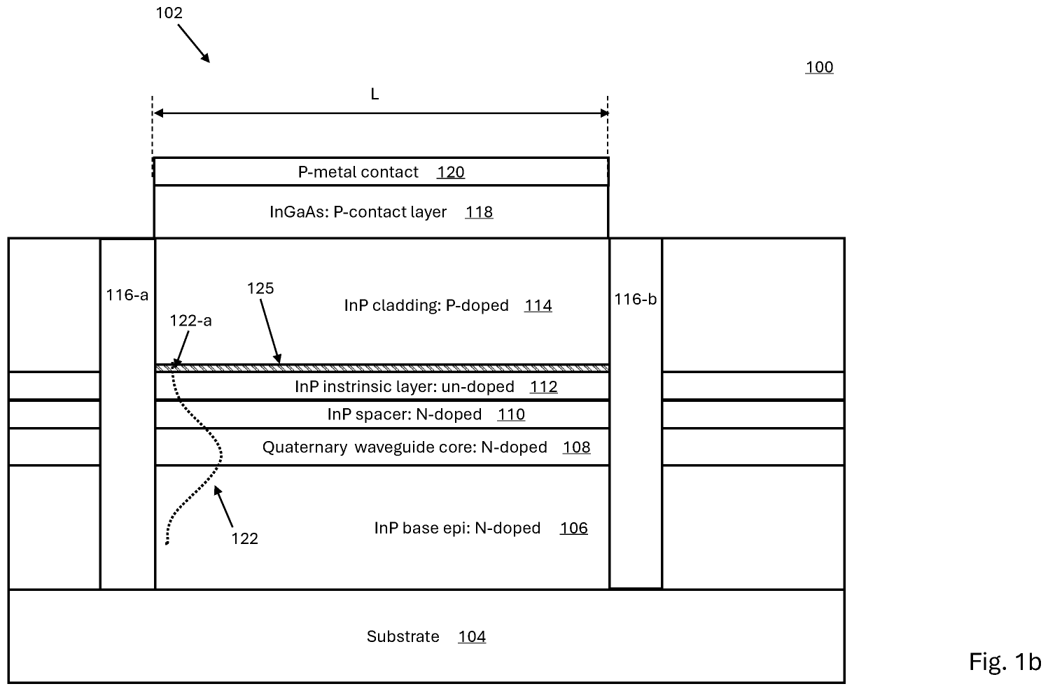

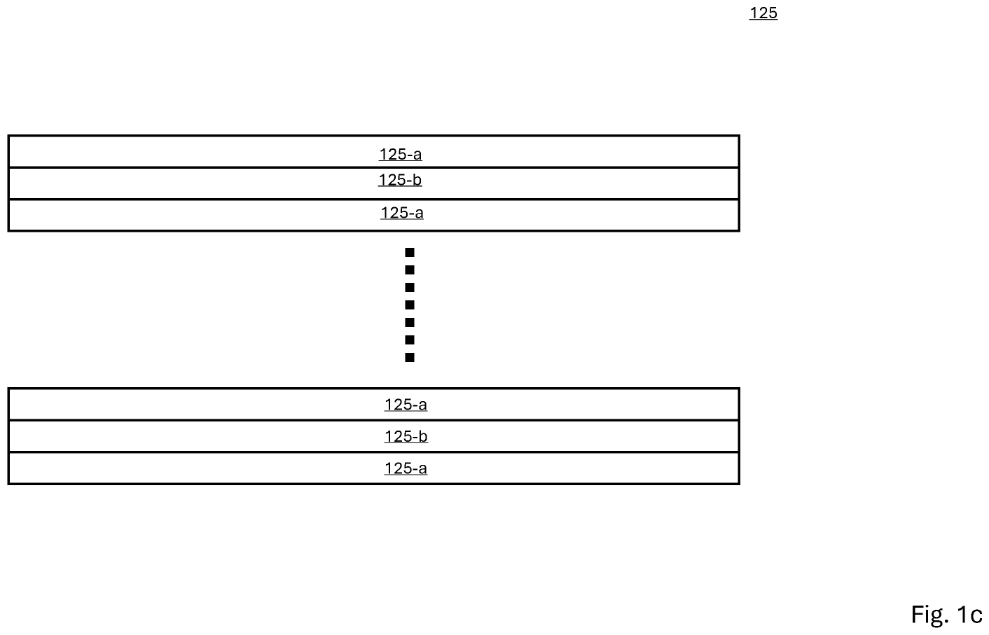

FIG. 1a illustrates a cross-sectional view of a waveguide 100 and power monitor formed thereon consistent with an aspect of the present disclosure. As shown in FIG. 1a, waveguide 100 is provided on substrate 104, which, in one example, is a semiconductor substrate. In a further example, substrate 104 includes indium phosphide (InP). An epitaxial layer 106, including, in one example, n-type InP, is provided on substrate 104, Epitaxial layer 106, in a further example, constitutes a lower cladding layer of waveguide 100. A further n-type or n-doped layer semiconductor layer 108, including, for example, a quaternary semiconductor material, such as indium gallium arsenide phosphide (InGaAsP) or other suitable quarternary semiconductor material, such as AlGaInAs, is provided on epitaxial layer 106. Layer 108, in a further example, constitutes a core layer of waveguide 100. A spacer semiconductor layer 110, for example, including n-type InP, is provided on layer 108, and an intrinsic semiconductor layer 112, for example, is provided on layer 110. Layer 112 may be undoped and include InP.

Consistent with an aspect of the present disclosure, an absorbing layer, which, in one example, is a multiple quantum well layer 125 is provided on layer 112. In one example and as generally understood, layer 125 includes alternating semiconductor layers having relatively wide and narrow bandgaps. FIG. 1c shows layer 125 in greater detail as including alternating layers 125-a and 125-b. In one example, the “wells” (layers 125-b) or narrow bandgap material includes indium gallium arsenide (InGaAs), which is undoped in one example or p-doped in another example, or a quaternary semiconductor material, and each of the “barriers” (layers 125-a) includes one or more of gallium arsenic phosphide (InAsP), InP, and aluminum gallium arsenide (AlGaAs).

As further shown in FIG. 1a, an upper cladding semiconductor layer 114 is provided layer 125 and portions of layer 112 not covered by layer 125. Layer 114, in one example, includes p-type or p-doped InP. A contact semiconductor layer 118 is formed on layer 114 which includes, in one example, p-doped InGaAs. In addition, a metal contact 120 is provided on layer 118. In one example, power monitor 102 constitutes layers 125, 118, 120, as well as portions of layers 114, 112, 110, 109, 106, and substrate 104 beneath layer 125. Power monitor 102, in this example, has a length L, which is coextensive with layer 125.

In a further example, power monitor 102 constitutes a reverse biased diode, whereby the metal contact 120 is biased to ground and the substrate 104 is biased positively. In an alternative embodiment, a negative bias is applied metal contact 120 and substrate 104 is set to a ground potential.

During operation, an optical signal having a spatial configuration or mode 122-a propagates from left to right in FIG. 1a. A portion of mode 122 constitutes an evanescent tail 122-a, which extends into layer 125, whereby light in tail 122-a creates electron-hole pairs that constitute a photocurrent that flows between metal contact 120 and substrate 104. A magnitude of such current is indicative of the optical power of the optical signal, and thereby facilitate monitoring such optical power by circuitry connected to contact 120. Since the tail is absorbed, the bulk of optical mode 122 continues to propagate in the waveguide, such that the power monitor is considered to be “in-line.”

As further shown in FIG. 1a, regions 116-a and 116-8 may be implanted, for example, to electrically isolate the above-noted photocurrent. Regions 116-a and 116-b may be formed by ion implantation of helium (He) or hydrogen (H) into layer 114 on opposite sides of layer 125, for example.

In a further example, each “well” layer, e.g., layer 125-b in FIG. 1c, has a thickness of 30-200 Angstroms and may be strained or unstrained. One to 10 such well layers may be provided, in one example. In another example, the sum of the thicknesses of layers 110 and 112 is in a range of 0 (both layers are omitted) and 1 micron.

It is noted that bulk material has a spectrally non-uniform absorption coefficient due to density of states. In one example, layer 125 has one quantum well, which has a single state, which is a ground state which is absorptive at a wavelength associated with the optical signal or optical mode propagating in the waveguide. Consistent with an aspect of the present disclosure, the first quantum state associated with the quantum wells in layer 125 has an absorption spectrum that is flatter than bulk material. In addition, by introducing strain to the “well” layer, the absorption spectrum can be shifted. A further advantage associated with an aspect of the present disclosure is that exciton peaks can be avoided or reduced.

Consistent with an additional aspect of the present disclosure, low mode overlap (˜0.1%-1.5%) with the quantum well layer 125 results in a significantly reduced reflection and significantly reduced perturbation to the optical mode. In addition, the power ratio of absorption can be arbitrarily and accurately controlled by scaling the length L of power monitor 120 so that optical loss can be minimized. Further, the optical signal experiences no excess loss compared to other conventional power monitors, such as coupler based power monitors.

Power monitor 102 shown in FIG. 1b is similar to that shown in FIG. 1a, except that implanted regions 116-a and 116-b extend to substrate 104 to provide further electrical isolation of power monitor 102 compared to that shown in FIG. 1a.

Consistent with an additional aspect of the present disclosure, the power monitor 102 may instead be operated as a variable optical attenuator by appropriately applying a varying amounts of a negative bias across contact 120 and substrate 104. Namely, at relatively strong or high negative bias, layer 125 is more absorptive, whereas at relatively low negative bias, layer 125 is less absorptive to thereby realize varying attenuation.

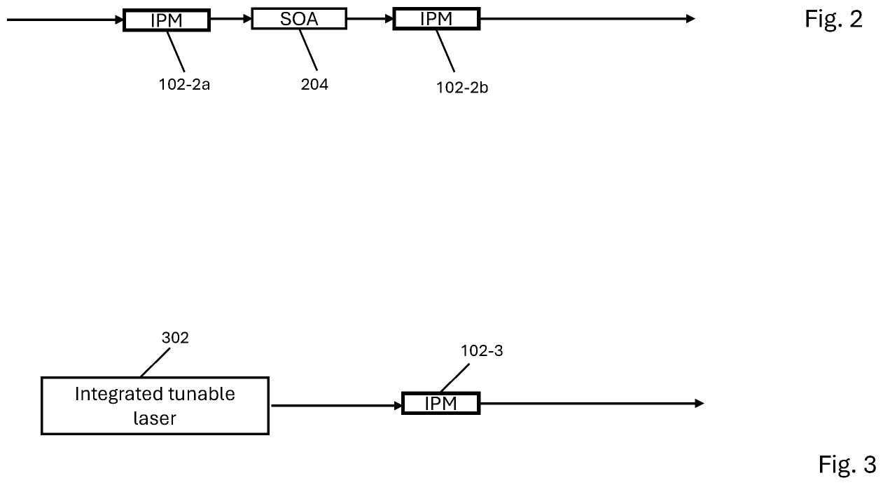

The above described structures may be provided at various locations on a PIC consistent with a further aspect of the present disclosure to provide power monitoring and/or variable attenuation. Such PIC locations will next be described with reference to FIGS. 2-8 below. It is noted that devices identified below with reference characters having the prefix “102” correspond to the structures discussed above with reference to FIGS. 1a and 1b. Each of the devices shown in FIGS. 2-8 may be provided as part of a photonic integrated circuit provided on a substrate, such as substrate 104.

FIG. 2 illustrates an example in which a first power monitor (or variable optical attenuator (VOA)) 102-2a is provided at an input to semiconductor optical amplifier (SOA) 204, and a second power monitor (or VOA) 102-2b is provided at the output of SOA 204 to monitor or selectively attenuate the optical signal input to and output from SOA 204.

In a further example shown in FIG. 3, the light output from an integrated tunable laser 302 provided in a PIC may be either monitored or selectively attenuated by monitor (or VOA) 102-3.

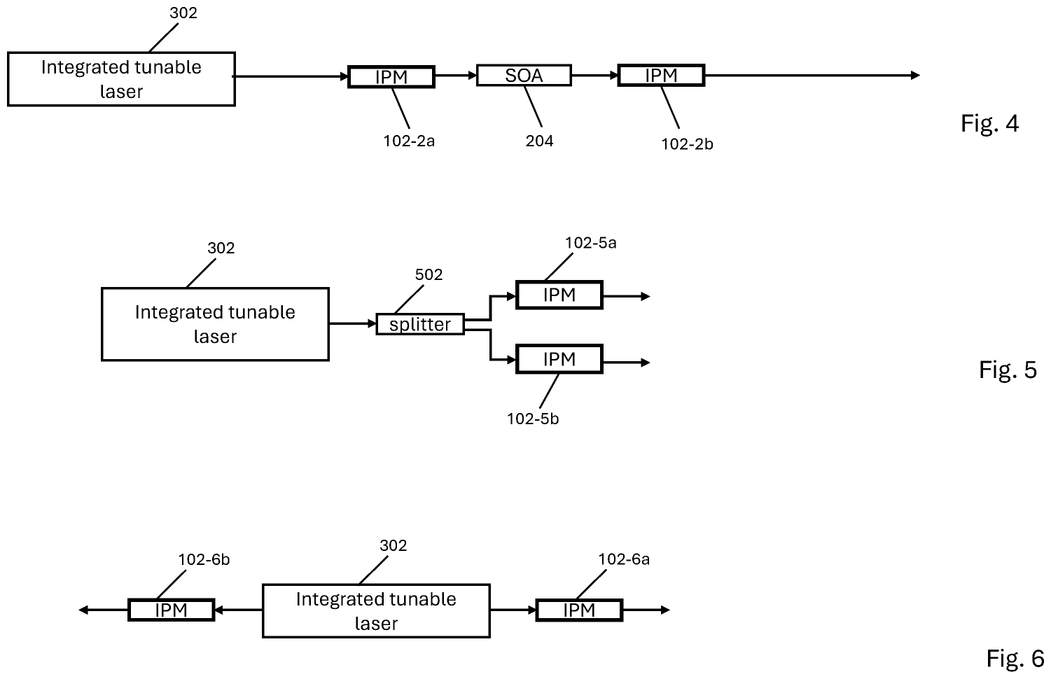

In the example shown in FIG. 4, light is output from laser 302 and is input to monitor (or VOA) 102-2a, which supplies an output to SOA 204. The output of SOA 204, in turn, is fed to monitor (or VOA) 102-2b. Here, the laser output and the output of SOA 204 may be monitored or selectively attenuated consistent with an aspect of the present disclosure.

FIG. 5 illustrates a further example where an optical splitter 502 is provided at the output of laser 302. Splitter 502 receives light supplied by laser 302 and provides a first portion of such light to a first monitor (or VOA) 102-5a and a second portion of such light to a second monitor (or VOA) 102-5b. In this example, the outputs of splitter 502 may be monitored or selectively attenuated as noted above.

FIG. 6 shows an example in which light is output from both sides of laser 302 and a first monitor (or VOA) 102-6a receives light output from a first side and a second monitor 102-6b (or VOA) receives light output from a second side of lasers 302. In the example shown in FIG. 6, light output from both sides of laser 302 is monitored or selectively attenuated.

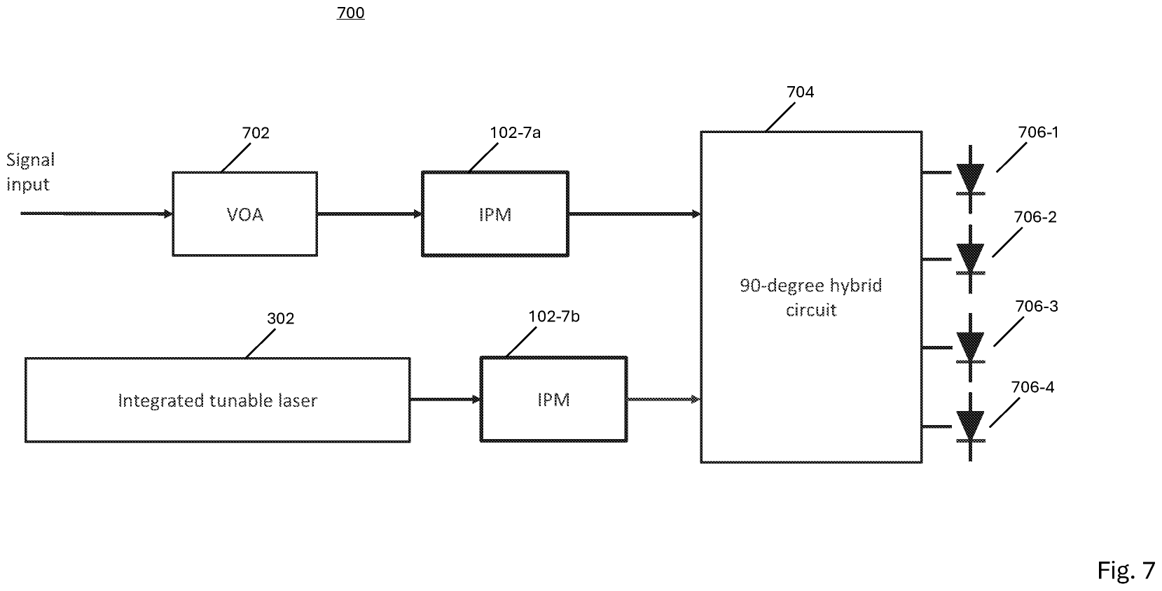

FIG. 7 shows an optical receiver 700 consistent with a further aspect of the present disclosure. Receiver 700 includes an optical signal input that receives an incoming optical signal. A VOA having a structure, for example, similar to that shown in FIG. 1a or 1b, may be provided to controllably adjust the power of the incoming optical signal. The attenuated optical signal may then be provided to a monitor 102-7a that detects the power of the attenuated optical signal and supplies the optical signal to 90-degree optical hybrid circuitry 704.

As further shown in FIG. 7, integrated tunable laser 302, which operates as a local oscillator laser, provides a local oscillator (LO) optical signal to monitor (or VOA) 102-7b, which monitors or selectively attenuates the LO signal and supplies the monitored or attenuated LO signal to hybrid circuitry 704, which mixes the LO signal with the incoming signal output from monitor 102-7a to provides a plurality of mixing products. Each of the plurality of mixing products is provided to a respective one of photodiodes 706-1 to 706-4.

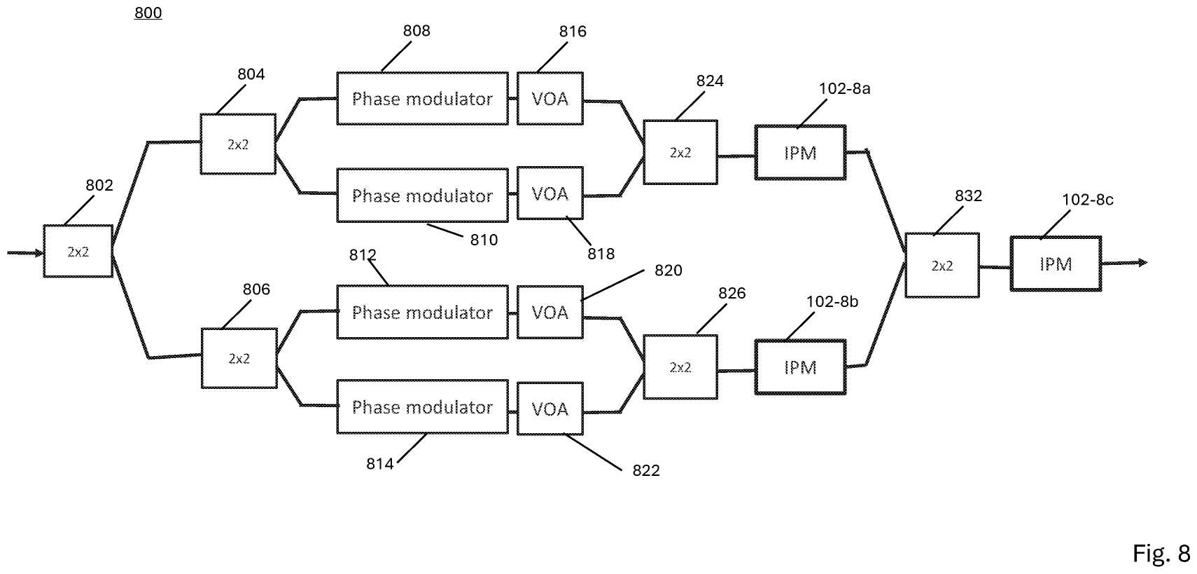

FIG. 8 shows an example of a transmitter 800 consistent with an additional aspect of the present disclosure. In FIG. 8, light output from a laser, such as laser 302 is provided to a 2×2 coupler 802. Coupler 802 has a first output that supplies a first portion of the received light to a further 2×2 coupler 804 and a second output that supplies the second portion of the received light to an additional 2×2 coupler 806. The light is divided again by couplers 804 and 806, which collectively have four outputs, such that each output supplies a corresponding optical portion to a respective phase modulators 808, 810, 812, and 814. The phase modulated output of each such modulator is supplied to a respective one of VOAs 816, 8128, 820, and 822. Each such VOA may have a structure similar to that shown in FIG. 1a or FIG. 1b. The outputs of VOA 816 and 818 are combined by coupler 824, and the outputs of VOAs 820 and 822 are combined by coupler 826. The output of coupler 824 is provided to monitor (or VOA) 102-8a and the output of coupler 826 is provided to monitor (or VOA) 102-8b. As further shown in FIG. 8, the outputs of monitors (or VOAs) 102-8a and 102-8b are combined by coupler 832 and provided to an output monitor (or VOA) 102-8c prior to transmission to an optical fiber (not shown).

Thus, in the example shown in FIG. 8 monitoring or selective attenuation may be provided by monitors (or VOAs) 102-8a to 102-8c.

In one example, phase modulators 808 and 810 operate in a push-pull manner to provide an in-phase modulated optical signal, and phase modulators 812 and 814 operate in a push-pull manner to provide a quadrature modulated optical signal.

Other embodiments will be apparent to those skilled in the art from consideration of the specification. It is intended that the specification and examples be considered as exemplary only, with a true scope and spirit of the invention being indicated by the following claims.

What is claimed is:

1. An apparatus, comprising:
a substrate;
a waveguide provided on the substrate;
a layer including at least one quantum well provided on a portion of the waveguide, whereby the layer and waveguide are configured such that an evanescent tail of an optical mode propagating in the waveguide extends into said at least one quantum well to thereby generate electron-hole pairs that constitute a photocurrent.

2. An apparatus in accordance with claim 1, wherein the quantum well has a single state, which is a ground state that is absorptive at a wavelength associated with the optical mode.

3. An apparatus in accordance with claim 1, further including a contact layer provided on the waveguide.

4. An apparatus in accordance with claim 2, where a length of the contact layer is coextensive with a length of the layer including said at least one quantum well.

5. An apparatus in accordance with claim 1, wherein the waveguide includes:
a cladding layer; and
an intrinsic layer, the layer including said at least one quantum well being provided between the intrinsic layer and the cladding layer.

6. An apparatus in accordance with claim 1, the layer including said at least one quantum has a thickness in a range of 30 angstroms to 200 angstroms.

7. An apparatus in accordance with claim 5, further including a spacer layer, the intrinsic layer being between the spacer layer and the layer including said at least one quantum well.

8. An apparatus in accordance with claim 7, wherein the spacer layer is n-type.

9. An apparatus in accordance with claim 1, further including a semiconductor optical amplifier that is operable to output an optical signal, the optical signal being associated with the optical mode.

10. An apparatus in accordance with claim 1, further including a semiconductor optical amplifier that receives an optical signal, the optical signal being associated with the optical mode.

11. An apparatus in accordance with claim 1, further including a laser that is operable to output an optical signal, the optical signal being associated with the optical mode.

12. An apparatus in accordance with claim 1, including:
a laser; and
a splitter, the splitter having a first output that supplies a first portion of an optical signal output from the laser, and a second output that supplies a second portion of the optical signal output from the laser, the optical mode being associated with the first portion of the optical signal output from the laser.

13. An apparatus in accordance with claim 1, further including a laser having a first side that provides a first optical signal and a second side that provides a second optical signal, the optical mode being associated with the first optical signal

14. An apparatus in accordance with claim 1, further including an optical receiver, the optical receiver including:
an input that receives an incoming optical signal; and
an optical hybrid circuit, the optical mode being associated with the incoming optical signal, such that the optical mode is provided as an input to the optical hybrid circuit, and the photocurrent being indicative of the optical power of the incoming optical signal.

15. An apparatus in accordance with claim 1, further including an optical receiver, the optical receiver comprising:
a local oscillator laser that provides a local oscillator signal; and
an optical hybrid circuit, the optical mode being associated with the local oscillator signal, such that the optical mode is provided as an input to the optical hybrid circuit, and the photocurrent being indicative of the optical power of the local oscillator signal.

16. An apparatus in accordance with claim 14, further including a variable optical attenuator that attenuates the incoming optical signal, the optical mode being associated with the attenuated incoming optical signal.

17. An apparatus in accordance with claim 1, further including a transmitter, the transmitter comprising:
a modulator that provides a modulated optical signal, the modulated optical signal being associated with optical mode.

18. An apparatus in accordance with claim 4, wherein a reverse bias is applied across the substrate and the contact layer.

19. An apparatus in accordance with claim 18, wherein the reverse bias is a result of a ground potential applied to the contract layer and a positive bias is applied to the substrate.

20. An apparatus in accordance with claim 18, wherein the reverse bias is a result of a negative bias applied to the contract layer and a ground potential is applied to the substrate.
